(19) United States
(12) Patent Application Publication
(10) Pub. No.: US 2022/0244947 A1
(43) Pub. Date: Aug. 4, 2022

(54) LOCAL SOURCING OF PARTIAL DATA FOR APPLICATION UPDATES

(71) Applicant: Microsoft Technology Licensing, LLC, Redmond, WA (US)

(72) Inventors: Ferdinand SCHOBER, Bellevue, WA (US); Simon Lee COOKE, Seattle, WA (US)

(21) Appl. No.: 17/162,582

(22) Filed: Jan. 29, 2021

(51) Int. Cl. G06F 8/658; G06F 8/61; G06F 8/71; G06F 21/60; G06F 21/71

(52) U.S. Cl. CPC G06F 8/658; G06F 8/61; G06F 21/71; G06F 21/602; G06F 8/71

(57) ABSTRACT

A reduced-latency method for updating an application includes sourcing first data representing to a first portion of an application update from a local storage location, sourcing second data representing a remaining second portion of the application update from a remote storage location, and overwriting a currently-stored version of the application with the first data and the second data.

### BACKGROUND

Many application providers release and deploy “rolling patches” for an application installed on user devices between releases of full versions of the application title that are packaged, managed, and validated through a delivery service (e.g., Xbox Live®). For example, an installed application with version number 1.1 may be subsequently overwritten (in full or in part) by a subsequently-released fully-packaged updated version 1.2 of the application. In between the release of versions 1.1 and 1.2, the application provider may release one or more rolling patches to apply hotfixes and other updates prior to the major updates included in version 1.2 and/or updates that are included within or equivalent to version 1.2. These rolling patches can be quite cumbersome in size but can often be released more quickly than fully-packaged versions due to the fact that they may be controlled by the application developer rather than a centralized delivery service.

When installed, rolling patch files do not overwrite packaged data (e.g., the previous application version, such as 1.1); rather, the rolling patches are typically stored in a persistent storage location that is controlled by the application and separate from the application itself. When the application is executing, the application may implement logic to selectively retrieve data from the persistent storage location whenever an application read pointer reaches a point within the application executable that corresponds to rolling patch data within the persistent storage location.

In some cases, an updated version of an application (e.g., fully-packaged version 1.2) incorporates all of the rolling patches released between that updated version and the previous version (e.g., version 1.1). For this reason, downloading an updated version of the application may entail downloading some (or mostly) duplicate data that the user device already is already storing within the application-controlled persistent storage location. Existing user devices lack logic usable to determine how much or which parts of an application update are duplicative of data that is already stored locally in rolling-patch form. In some cases, an application update may contain gigabytes of data and can take several minutes or hours to download.

### SUMMARY

A reduced latency method of updating an application installed on a computing device comprises sourcing first data of the application update from a local storage location, sourcing second data of the application update from a remote storage location, and overwriting a currently-stored version of the application with the first data and the second data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other implementations are also described and recited herein.

### BRIEF DESCRIPTIONS OF THE DRAWINGS

FIG. 1A illustrates an exemplary system that locally sources some data of an application update while downloading other portions of the application update to reduce total download time and related bandwidth consumption.

FIG. 1B illustrates further actions of the system of FIG. 1A performed in the course of updating the application executable using a combination of locally-sourced data and data downloaded from a cloud-based server.

FIG. 2 illustrates aspects of another exemplary system that sources a portion of data for an application update from local storage of a client device on which the application update is to be installed while downloading other portions.

FIG. 3 illustrates another example system that sources a portion of data for an application update from local storage of a client device on which the application update is to be installed while downloading other portions.

FIG. 4 illustrates example operations for locally-sourcing some portions of an application update from a client device on which the application update is to be installed while downloading other portions from remote location(s).

FIG. 5 illustrates an example schematic of a processing device suitable for implementing aspects of the disclosed technology.

### DETAILED DESCRIPTIONS

The herein disclosed technology provides a mechanism that allows a device to identify which parts of an application update (e.g., both executable and non-executable data) the device has previously downloaded as part of one or more rolling patches for the application. With this insight, the device is able intelligently source some portions of the application update from persistent local storage (e.g., application-controlled storage where rolling patches reside) and other portions of the application update from remote storage (e.g., cloud-based server locations). For purposes of this disclosure, the term “application update” is intended to refer to a fully-packaged version of an application that is installed by overwriting all or part of a previously-installed fully-packaged version of the application. For example, version 1.1 of an application may be eventually overwritten by version 1.2, 1.3, and so forth. In contrast, a “patch” or “rolling patch” refers to an executable code segment for an application that is stored in a location redundant to the existing application executable. When the application is executed, the patch may be referenced and executed each time a read pointer reaches a predefined location within the application executable.

By intelligently sourcing some portions of an application update from a local persistent storage location and others from a cloud-based application server, a device may be able to effectively reduce the amount of data that is to be downloaded from the cloud-based server when obtaining the application update file(s). This translates to a large reduction in download latency associated with the application update.

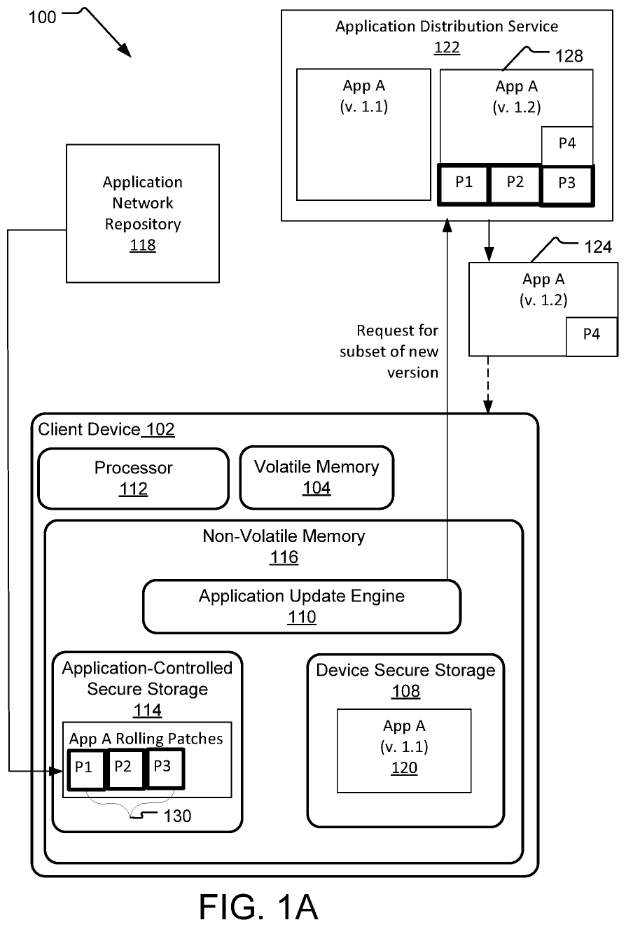

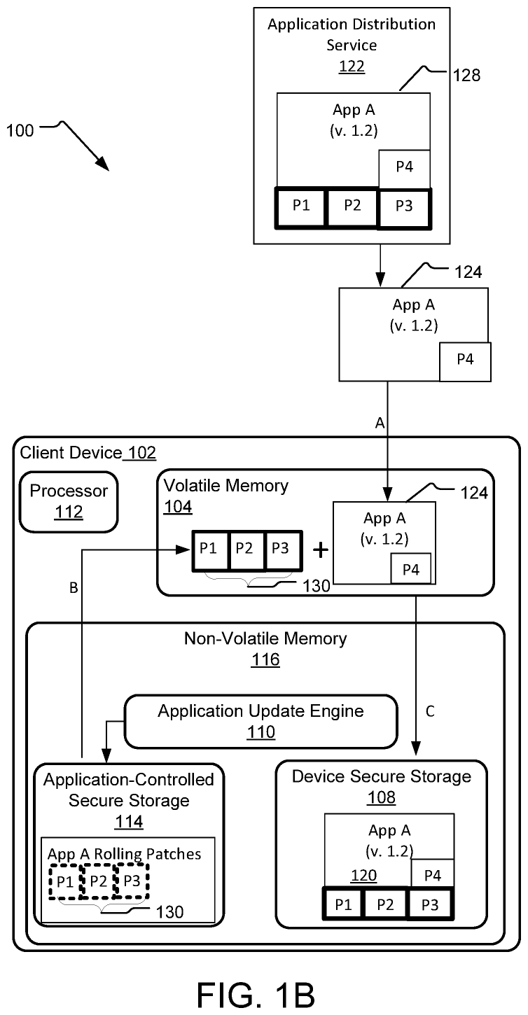

FIG. 1A illustrates an exemplary system 100 that locally sources some data of an application update while downloading other portions of the application update to reduce total download time and related bandwidth consumption. The system 100 includes a client device 102 including a processor 112 as well as both volatile memory 104 and non-volatile memory 116. The non-volatile memory 116 may be divided or partitioned into different storage regions in which the client device 102 enforces different permissions or security controls. By example and without limitation, the non-volatile memory 116 illustrates a first storage region referred to herein as “device secure storage 108” and a second storage region referred to herein as “application-controlled secure storage 114.”

In one implementation, the device secure storage 108 is an encrypted or otherwise-protected storage region that is accessible to the operating system (not shown) of the client device 102 and/or other high-level management tasks or processes. The device secure storage 108 is, for example, used to store application executables that may be launched by the operating system and executed by the processor 112. By example and without limitation, the device secure storage 108 is illustrated showing an executable application package 120 (“App A”) which may be understood as including one or several executable files that collectively form a fully-packaged version of the application. At run time of the application, the executable application package 120 for App A may be decrypted and loaded into the volatile memory 104 for execution by the processor 112.

In contrast to the device secure storage 108, the application-controlled secure storage 114 is a secure storage region controlled and accessed by various authorized applications on the client device 102. For example, the application-controlled secure storage 114 may be an encrypted region of a hard drive that acts like a virtual drive that is read and write accessible to certain authorized applications (e.g., App A). Non-authorized applications are denied both read and write access to the application-controlled secure storage 114 as well as access to the security controls (e.g., encryption/decryption engines) utilized on data stored therein.

Notably, the device secure storage 108 is shown to reflect a particular version (revision) number of the executable application package 120—v. 1.1. Over time, the developer of App A may release rolling patches for the application that client device 102 downloads from an application network repository 118, which may for example include one or more cloud-based servers. These rolling patches are stored in the application-controlled secure storage 114. By example and without limitation, the application-controlled secure storage 114 of FIG. 1A illustrates three rolling patches for App A—P1, P2, and P3. Each of these patches may be understood as including one or more executable files designed to be run in lieu of corresponding file(s) in the executable application package 120 for App A. Notably, the executable files stored in the application-controlled secure storage 114 are stored redundant to the corresponding files in the executable application package 120 for App A.

During execution of the files in the executable application package 120, logic is implemented to search the application-controlled secure storage 114 for rolling patches for each executable file and, if such a patch is found, the patch is executed instead of its corresponding files and/or logic within the executable application package 120.

Over time, as the number of patches stored in the application-controlled secure storage 114 grows more cumbersome, an application distribution service 122 may eventually release a fully-packaged updated version of an application (App A), which is intended to replace the executable application package 120 stored in the device secure storage 108.

The application distribution service 122 is, for example, a service managed by the developer of App A that stores and various revision-controlled versions of App A. In the illustrated, example, the application distribution service 122 stores and distributes version 1.1, which is already installed on the client device 102, as well as an updated version 128 (v. 1.2). The updated version 128 (v. 1.2) may typically include some data that is redundant of data included in rolling patches (P1, P2, P3, etc.) previously-released by the application network repository 118. For example, v. 1.2 of App A incorporates the data of patches P1, P2, P3, and P4, three of which (P1, P2, P3) have been already downloaded and stored within the application-controlled secure storage 114 of the client device 102.

Devices implementing existing technology typically download each new fully-packaged version of the executable application package 120 (App A) without regard for whether or not packaged data of the update already resides, in some form, on the client device 102. The system 100 improves upon these existing systems by including an application update engine 110 that performs actions effective to prevent duplicative download of application update data that the client device 102 has previously acquired, such as data written to the application-controlled secure storage 114 as part of a released rolling patch.

Instead of permitting the client device 102 to download the entire new version 126 of the application, the application update engine 110 identifies data chunks (files or subsets of files) within the updated version 128 that are already stored locally on the client device 102 in the application-controlled secure storage 114. These locally-stored data chunks are then selectively excluded from the download of the updated version 128 of the executable application package (v. 0.2 of App 1).

In the illustrated example, the application update engine 110 uniquely identifies the data included in the previously-downloaded and installed patches P1, P2, and P3 and selectively downloads a first portion 124 of the updated version 128 of the executable application package 120 that excludes the data of these three patches. As shown in greater detail with respect to the operations of FIG. 1B, the application update engine 110 then locally sources a second portion 130 of the updated executable application package from the application-controlled secure storage 114, and overwrites the executable application package 120 with the combination of both the downloaded first portion 124 and the locally-sourced second portion 130. This significantly reduces download time as compared to that requisite to download the full new version 128 of the application executable, saving the user perhaps hours of time waiting for the update of App A to complete.

Although the application update engine 110 is, in FIG. 1A, shown to be internal to the client device 102, alternate implementations may implement some or all logic of the application update engine 110 at a processing entity external to the client device 102. For example, some or all logic of the application update engine 110 may be executed by a third-party processing entity, such as a cloud-based server. In still other implementations, some or all logic of the application update engine 110 is executed by an operating system of the client device 102 or a secure application external to the operating system.

FIG. 1B illustrates further actions of the system 100 of FIG. 1A performed in the course of updating the executable application package 120 using a combination of data that is locally-sourced and data that is downloaded from a cloud-based server. After downloading the first portion 124 of the application update from the application distribution service 122 and into the volatile memory 104 of the client device 102, the application update engine 110 reads the second portion 130 of the application update from the application-controlled secure storage 114 into the volatile memory 104. Within the volatile memory 104, the first portion 124 and the second portion 130 are combined to generate the updated version 128 of the executable application package, which is in turn written to the device secure storage 108 in place of the previous version of the ap executable application package 120.

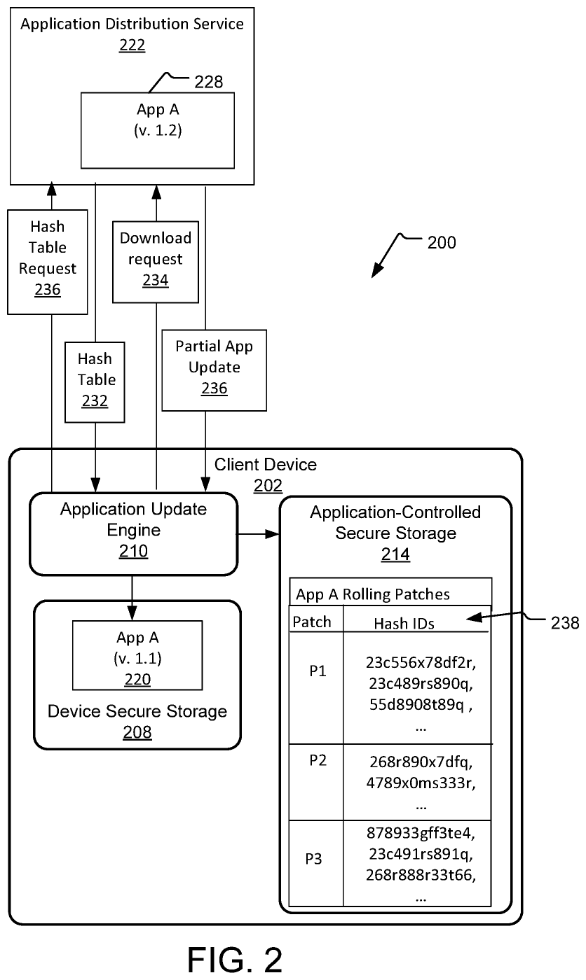

FIG. 2 illustrates aspects of another example system 200 that sources a portion of data for an application update from local storage of a client device 202 on which the application update is to be installed while downloading other portions from the cloud. In one implementation, the client device 202 includes the same or similar hardware and software elements as those described above with respect to FIG. 1A-1B including device secure storage 208 as well as application-controlled secure storage 214. In the illustrated example, the device secure storage 208 stores a first version (v. 1.1) of an application executable package 220 (“App A”) and the application-controlled secure storage 214 stores several rolling patches (P1, P2, P3, etc.) that have been released for the same application (App A) since the release of the first version (v. 1.1). The application-controlled secure storage 214 also stores one or more unique data chunk identifiers (e.g., hash IDs 238) in association with each of the released rolling patches, P1, P2 P3. In one implementation, each of the data chunk identifiers uniquely identifies to a discrete data chunk that is included in the associated patch P1, P2, or P3. For example, the application distribution service 222 or application network repository (not shown) applies a secure hashing algorithm such as SH256 to discrete chunks of data, thereby creating a hash ID for each of the discrete chunks that is usable to uniquely identify the data chunk. In the herein illustrated examples, the term data chunk identifier is used interchangeably with hash ID. However, it should be understood that a hash ID represents one suitable data chunk identifier and that other implementations my utilize alternate types of data chunk identifiers to further the same purpose.

The size and form of the discrete data chunk represented by each data chunk identifier may assume different forms in different implementations. In one implementation, a hash ID is created in association with each different filename in the rolling patches. In this case, a hash ID is usable to identify a full executable file, which may be an encrypted file. In another implementation, a hash ID is created in association with data chunks of a finite size, such as 4 KB, within an executable file. For example, the rolling patch P1 may include five executable files and the data within each individual executable file may be divided into data chunks that are each individually encrypted and, via the encryption process, assigned a unique hash ID value. In this, case, a single filename may include several uniquely-identifiable encrypted data chunks.

In the illustrated implementation, the application update engine 210 transmits a hash table request 236 to the application distribution service 222 responsive to determining that there exists an updated version 228 (v. 1.2) of App A available for download. For example, the client device 202 may receive a notification that the updated version 228 of the application executable package 220 is available for download or otherwise acquire such information, such as by sending a query to the application distribution service 222. In one implementation, the hash table request 236 requests hash data associated with a particular application (e.g., App A) and a particular version number (e.g., v. 1.2). For example, the application update engine 210 requests a hash table including hash IDs for data chunks included in version 1.2 of the App A.

Responsive to receipt of the hash table request 236, the application distribution service 222 locates and transmits a hash table 232 that satisfies the request (e.g., that is associated with the identified application and specified version number) back down to the client device 202. In one implementation, the hash table 232 includes a hash ID associated with each different individually-encrypted data chunk (e.g., filename or discrete segment of executable data) within the updated version 228 of the application. The hash IDs generated for the different data chunks of the updated version 128 are, in one implementation, created using encryption algorithms and techniques that are identical to those used to generate the hash IDs associated with the rolling patches (P1, P2, and P3) previously-downloaded to and installed on the client device 202. In this sense, identical hash IDs represent identical protected data chunks within any of the rolling patches (P1, P2, P3) and the various different versions of the associated application (App A).

Upon receipt of the hash table 232, the application update engine 210 performs actions to determine if any of the hash IDs in the hash table 232 are also stored within the application-controlled secure storage 214. In one implementation where the hash table 232 is sent to the client device 202 in encrypted form, the client device 202 decrypts the hash table 232 upon receipt. Likewise, the application update engine 210 calls on App A or other authorized application to read the hash IDs stored in association with data in the application-controlled secure storage 214, and this data is also decrypted. The application update engine 210 compares each hash ID in the decrypted version of the hash table 232 to each of the hash IDs decrypted and retrieved from the application-controlled secure storage 214. Using such information, the application update engine 210 identifies a subset of hash IDs included in the hash table 232 that are duplicatively-stored in association with data within the application-controlled secure storage 214.

Based on the above-described comparison and the identified subset of duplicative hash IDs, the application update engine 210 removes from the hash table 232 the identified hash IDs corresponding to data chunks already residing in the application-controlled secure storage 214. These data chunks are referred to herein as the “locally-sourced portion of the application update.” The application update engine 210 then generates a download request 234 that identifies the residual hash IDs still remaining on the redated version of the hash table 232 after the removal of the data chunks representing the locally-sourced portion of the application update. If, for example, the hash table 232 initially includes hash IDs identifying data chunks A-F and the application-controlled secure storage 214 stores hash IDs identifying data chunks B and F (e.g., B and F were previously downloaded as part of one of the rolling patches P1, P2, or P3), the download request 234 includes the hash IDs for data chunks A, C, D, and E and excludes the hash IDs for the data chunks B and F, which already reside on the client device 202. Stated differently, the download request 234 uniquely identifies the subset of data within the updated version 228 of the application that does not yet reside anywhere on the client device 202.

Responsive to the download request 234, the application distribution service 222 transmits a partial application update 226 that includes the data chunks identified by the download request 234 and that excludes the data chunks identified as residing within application-controlled secure storage 214. This partial application update 226 is referred to herein as the “remotely-sourced portion of the application update.” The application update engine 210 then combines, in volatile memory (not shown), the remotely-sourced portion of the application update with the locally-sourced portion of the application update and overwrites the application executable package 220 with an encrypted version of the combined data, such as in the manner described with respect to FIGS. 1A and 1B.

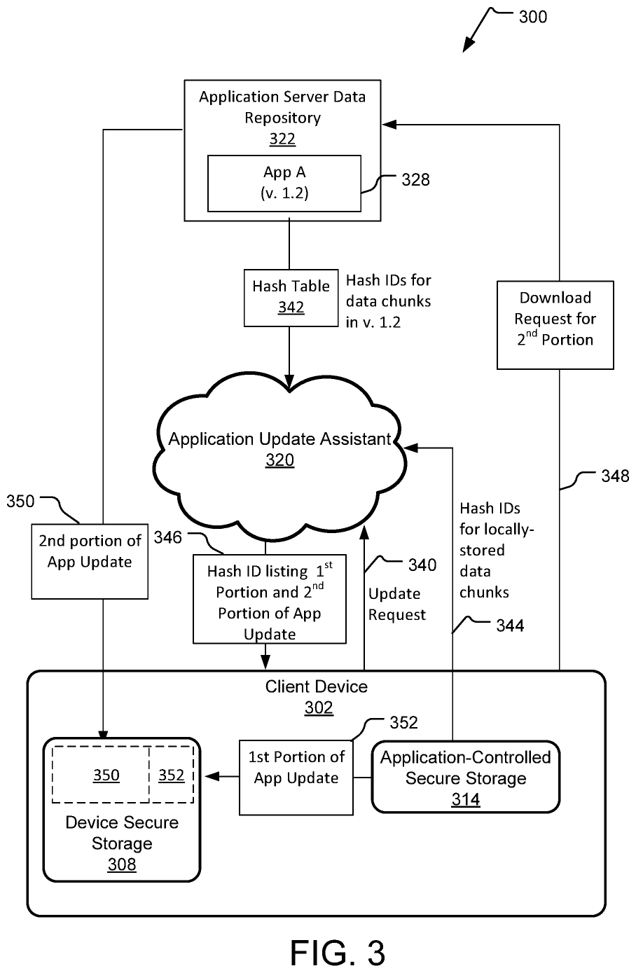

FIG. 3 illustrates another example system 300 that sources a portion of data for an application update from local storage of a client device 302 on which the application update is to be installed while downloading other portions from remote storage location(s). In one implementation, the client device 302 includes the same or similar hardware and/or software elements as those shown and described with respect to other figures herein. Specifically, the client device 302 includes device secure storage 308 as well as application-controlled secure storage 314. The system 300 differs from those of FIG. 1A, FIG. 1B, and FIG. 2 in that some or all actions performed by the application update engine (previously shown and described as internal to the client device 302) are, in FIG. 3, performed by a cloud-based application update assistant 320. In one implementation, the cloud-based application update assistant 320 is a third-party cloud-based service provider. When the client device 302 becomes aware of an available update 328 for an application that is installed within the device secure storage 308 (e.g., by receiving a notification or otherwise), the client device 302 transmits an update request 340 to the application update assistant 320. The update request 340 identifies a requested application update such as by specifying an application title for update and a requested revision number (e.g., v. 1.2).

Responsive to receipt of the update request 340, the application update assistant 320 retrieves a hash table 342 from an application server data repository 322 that corresponds to the requested update 328. The hash table 342 includes a listing of hash IDs identifying all data chunks included within the requested update 328, where each data chunk uniquely identifies a different discrete data chunk. In addition to retrieving the hash table 342 for the requested update 328, the application update assistant 320 also obtains, from the client device 302, a listing of hash IDs for locally-stored data chunks 344 that reside in application-controlled secure storage 314 in association with the application that is to be updated. For instance, the locally-stored data chunks represent data within one or more rolling patches previously-downloaded and installed for the application and stored separately from the fully-packaged application executable within the client device 302.

The application update assistant 320 compares the hash IDs for the locally-stored data chunks 344 to those hash IDs included in the hash table 342 and determines which parts of the application update 328 can be locally-sourced from the application-controlled secure storage 314. The application update assistant 320 transmits hash ID information 346 identifying a first subset of data chunks that are included in a locally-stored first portion of the application update and a second subset of data chunks that are not yet locally stored on the client device 302. With this hash ID information 346, the client device 302 is able to read the locally-stored first portion of the application update into the device secure storage 308 and use the locally-stored first portion to update (overwrite) corresponding portions of the application executable.

Likewise, the client device is able to transmit a download request 348 for the remaining second portion of the application update that is not yet locally stored on the client device 302. In response, the application server data repository 322 transmits the requested second portion 350 of the application update down to the client device 302, where the received data is used to update (overwrite) corresponding portions of the application executable.

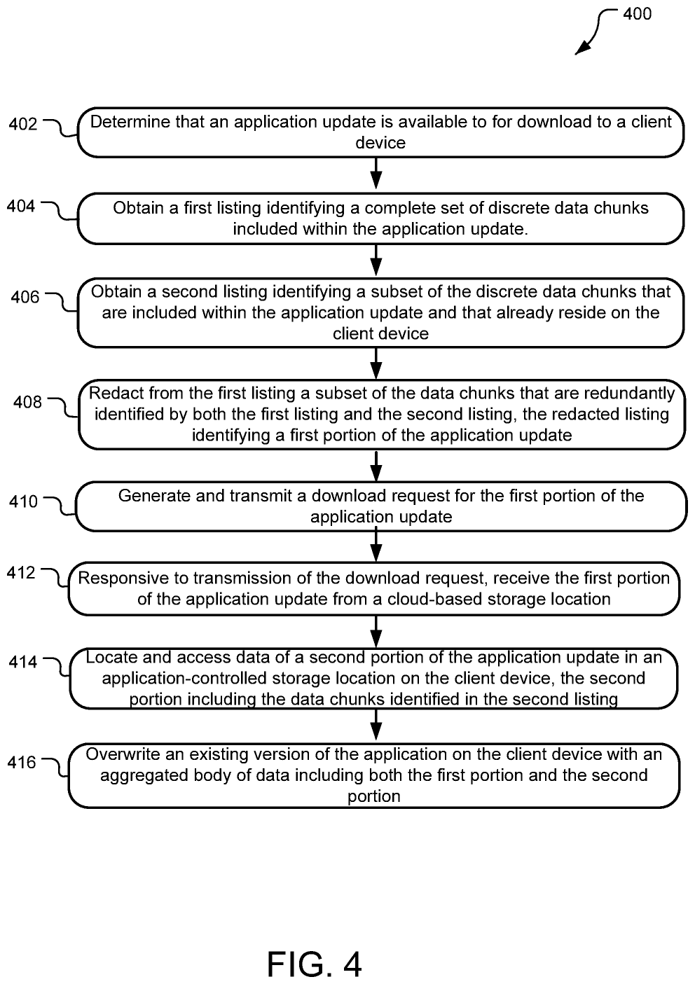

FIG. 4 illustrates example operations 400 for locally-sourcing some portions of an application update from a client device on which the application update is to be installed while downloading other portions from remote location(s). A determining operation 402 determines that an application update is available for download to a client device on which a version of the application is currently installed. An obtaining operation 404 obtains a first listing identifying a complete set of discrete data chunks included within the application update. In one implementation, the first listing uniquely identifies each of the discrete data chunks via a data chunk identifier, which may be a hash ID generated during an encryption operation. For example, the first listing may be requested from and provided by a cloud-based application distribution service.

Another obtaining operation 406 obtains a second listing identifying a subset of the discrete data chunks that are included within the application update and that already reside on the client device. For example, the second listing identifies data chunks previously downloaded and stored to the client device as part of one or more rolling patches released for the application. In one implementation where the client device stores rolling patches in a secure storage region, the obtaining operation 406 may entail both reading and decrypting data from the secure storage region to extract data chunk identifiers (e.g., hash IDs) stored in association with the rolling patch data.

A redacting operation 408 redacts from the first listing (obtained in 404) a subset of the data chunks that are redundantly identified by both the first listing and the second listing. Stated differently, the redacting operation 408 modifies the first listing to remove reference to data chunks of the application update that are already locally-stored on the client device such that the modified listing identifies the data chunks of the application update that are not yet locally stored on the client device. In the remainder of this example, the subset of data chunks that are not yet locally-stored on the client device are collectively referred to as the “first portion of the application update” while the subset of data chunks already residing in local storage on the client device are referred to as the “second portion of the application update.”

A requesting operation 410 generates and transmits a request to download the first portion of the application update. This request may, for example, including a listing of data chunk identifiers (hash IDs) usable to uniquely identify all data chunks included in the first portion of the application update. A receiving operation 412 receives, responsive to transmission of the download request, the first portion of the application update.

A locating and accessing operation 414 locates and accesses data of the second portion of the application update at corresponding locations in local storage, such as within application-controlled secure storage. The locating and accessing operation 414 may entail decrypting and reading into volatile memory each data chunk of the second portion.

An overwrite operation 416 overwrites an existing version of the application with an aggregated body of data including both the first portion and the second portion of the application update.

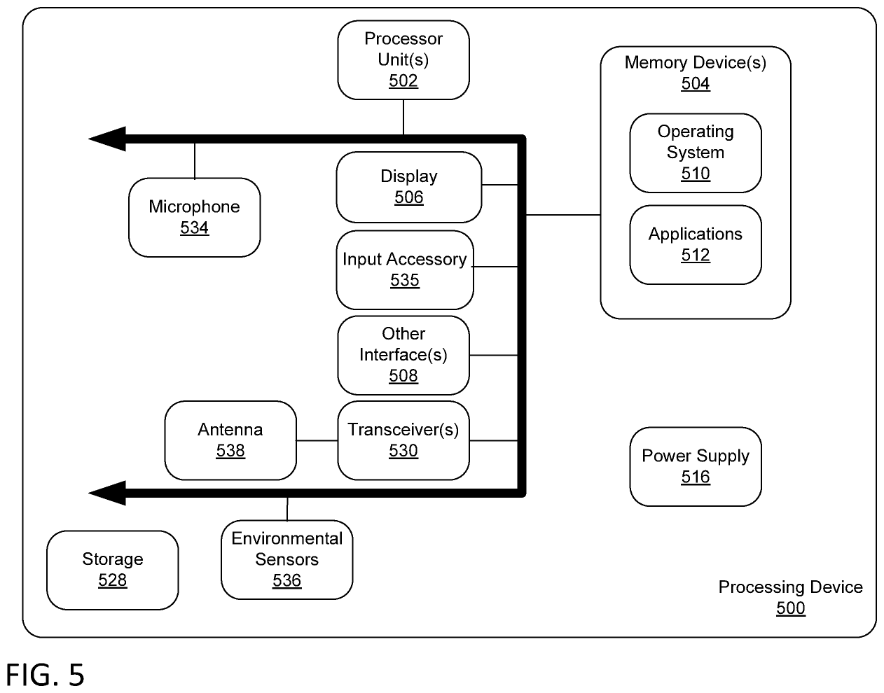

FIG. 5 illustrates an example schematic of a processing device 500 suitable for implementing aspects of the disclosed technology. The processing device 500 includes one or more processor unit(s) 502, memory 504, a display 506, and other interfaces 508 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system or the Xbox® operating system, resides in the memory 504 and is executed by the processor unit(s) 502, although it should be understood that other operating systems may be employed.

One or more applications 512, such as the executable application package 120 or the application update engine 110 of FIG. 1 are loaded in the memory 504 and executed on the operating system 510 by the processor unit(s) 502. Applications 512 may receive input from various input devices such as a microphone 534, input accessory 535 (e.g., keypad, mouse, stylus, touchpad, gamepad, racing wheel, joystick), or inputs from various environmental sensors 536 such as one or more cameras, microphones, etc. The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 includes one or more communication transceivers 530 and an antenna 538 to provide network connectivity (e.g., a mobile phone network, Wi-Fi®, Bluetooth®). The processing device 500 may also include various other components, such as a positioning system (e.g., a global positioning satellite transceiver), one or more accelerometers, one or more cameras, an audio interface (e.g., the microphone 534, an audio amplifier and speaker and/or audio jack), and storage devices 528. Other configurations may also be employed.

In an example implementation, an operating system and various applications and other modules and services may have hardware and/or software embodied by instructions stored in the memory 504 and/or the storage devices 428 and processed by the processor unit(s) 502. The memory 504 may be the memory of a host device or of an accessory that couples to the host.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

An example method disclosed herein includes sourcing first data representing to a first portion of an application update from a local storage location; sourcing second data representing a remaining second portion of the application update from a remote storage location and overwriting a currently-stored version of the application with the first data and the second data.

Another example method according to any preceding method includes obtaining a listing of data chunk identifiers that collectively identify data included within the application update; identifying “first data” by redacting from the listing a subset of the data chunk identifiers corresponding to data chunks previously-installed by the computing device as part of one or more rolling patches released for the application; and generating a download request for “second data,” where the download request identifies data chunks corresponding to the data chunk identifiers on the redacted listing.

In still another example method of any preceding method, the data chunk identifiers each identify an encrypted file within the application update.

In yet another example method of any preceding method, each file of the application update is associated with multiple of the data chunk identifiers, and each of the data chunk identifiers identifies an individually-encrypted subset of the file.

In another example method of any preceding method, the method further comprises: receiving and reading into volatile memory the second data from the remote storage location responsive to transmission of the download request; reading into the volatile memory the first data from the local storage location of the computing device; combining the first data and the second data; encrypting the combined first data and the second data; and overwriting the application with the encrypted combined first data and the second data.

In another example method of any preceding method, the local storage location is a secure storage region on the computing device that is read and write accessible to a pre-authorized subset of applications including the application.

In still another example method of any preceding method, the remote storage location includes a server of a cloud-based application distribution service.

In yet still another example method of any preceding method, the first data is sourced from a previously-installed rolling patch for the application that is stored on the computing device in addition to the application.

In another example method of any preceding method, the first data and the second data are mutually exclusive portions of the application update.

An example system disclosed herein includes an application update engine stored in memory and executable to: obtain first data from a local storage location of a computing device, the first data representing to a first portion of an application update; obtain second data from a storage location remote from the computing device, the second data representing a remaining second portion of the application update; and overwrite a currently-stored version of the application with aggregated data including both the first data and the second data.

In another example system according to any preceding system, the application update engine is further executable to obtain a listing of data chunk identifiers that identify data included within the application update and to redact from the listing of data chunk identifiers a subset of the data chunk identifiers corresponding to data chunks previously-installed by the computing device as part of one or more rolling patches released for the application, where the subset of data chunk identifiers represent the “first data.: The application update engine is further executable to generate a download request for the second data, the download request identifying data chunks corresponding to the data chunk identifiers on the redacted listing.

In still another example system of any preceding system, the data chunk identifiers each identify an encrypted file within the application update.

In yet still another example system of any preceding system, each file of the application update is associated with multiple of the data chunk identifiers, each of the data chunk identifiers uniquely identifying an individually-encrypted subset of the file.

In still another example system of any preceding system, the application update engine is further executable to: receive and read into volatile memory of the computing device the second data responsive to transmission of the download request; copy into the volatile memory the first data from the local storage location of the computing device; combine the first data and the second data within the volatile memory; encrypt the combined first data and the second data; and overwriting the application with the encrypted combined first data and the second data.

In yet another example system of any preceding system, the local storage location is a secure storage region on the computing device that is read and write accessible to a pre-authorized subset of applications including the application.

In still another example system of any preceding system, the remote storage location includes a server of a cloud-based application distribution service.

In yet still another example system of any preceding system, the first data is sourced from a previously-installed rolling patch for the application that is stored on the computing device in addition to the application.

An example tangible computer-readable storage media disclosed herein encodes computer-executable instructions for executing a computer process for updating an application installed on a computing device. The computer process includes sourcing first data representing to a first portion of an application update from a local storage location; sourcing second data representing a remaining second portion of the application update from a remote storage location; and overwriting a currently-stored version of the application with the first data and the second data.

In another example tangible computer-readable storage media of any preceding storage media, the encoded computer process further includes: obtaining a listing of data chunk identifiers that collectively identify data included within the application update; And redacting from the listing of data chunk identifiers a subset of the data chunk identifiers corresponding to data chunks previously-installed by the computing device as part of one or more rolling patches released for the application, where the subset of data chunk identifiers representing the first data. The computer process further comprises generating a download request for the second data, where the download request identifies data chunks corresponding to the data chunk identifiers on the redacted listing.

In another example tangible computer-readable storage media of any preceding storage media, the data chunk identifiers in the listing each identify an encrypted file within the available application update.

An example system disclosed herein includes a means for sourcing first data representing to a first portion of an application update from a local storage location, a means for sourcing second data representing a remaining second portion of the application update from a remote storage location, and a means for overwriting a currently-stored version of the application with the first data and the second data.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendix, provide a complete description of the structure and use of exemplary implementations.

1. A method of updating an application installed on a computing device, the method comprising:
obtaining a listing of hash identifiers (IDs) associated with an application update, each of the hash IDs identifying a data chunk included within the application update;
redacting from the listing of hash IDs a subset of the hash IDs corresponding to data chunks previously-installed by the computing device, the subset of redacted hash IDs representing first data of the application update;
generating a download request for second data of the application update, the download request identifying data chunks corresponding to the hash IDs remaining on the redacted listing;
sourcing the first data of the application update from a local storage location;
sourcing the second data of the application update from a remote storage location based on the download request; and
overwriting a currently-stored version of the application with the first data and the second data.

2. (canceled)

3. The method of claim 1, wherein the hash IDs each identify an encrypted file within the application update.

4. The method of claim 1, wherein each file of the application update is associated with multiple of the hash IDs, each of the hash IDs identifying an individually-encrypted subset of the file.

5. The method of claim 1, further comprising:
responsive to transmission of the download request, receiving and reading into volatile memory the second data from the remote storage location;
reading into the volatile memory the first data from the local storage location of the computing device;
combining the first data and the second data;
encrypting the combined first data and the second data; and
overwriting the application with the encrypted combined first data and the second data.

6. The method of claim 1, wherein the local storage location is a secure storage region on the computing device that is read and write accessible to a pre-authorized subset of applications including the application.

7. The method of claim 1, wherein the remote storage location includes a server of a cloud-based application distribution service.

8. The method of claim 1, wherein the first data is sourced from a previously-installed rolling patch for the application that is stored on the computing device in addition to the application.

9. The method of claim 1, wherein the first data and the second data are mutually exclusive portions of the application update.

10. A system comprising:
an application update engine stored in memory and executable to:
obtain a listing of hash identifiers (IDs) associated with an application update, each of the hash IDs identifying a data chunk included within the application update;
redact from the listing of hash IDs a subset of the hash IDs corresponding to data chunks previously-installed by the computing device as part of one or more rolling patches released for the application, the subset of redacted hash IDs representing first data of the application update;
generate a download request for second data of the application update, the download request identifying data chunks corresponding to the hash IDs remaining on the redacted listing;
obtain the first data of the application update from a local storage location of a computing device;
obtain the second data of the application update from a storage location remote from the computing device; and
overwrite a currently-stored version of the application with aggregated data including both the first data and the second data.

11. (canceled)

12. The system of claim 10, wherein the hash IDs each identify an encrypted file within the application update.

13. The system of claim 10, wherein each file of the application update is associated with multiple of the hash IDs, each of the hash IDs uniquely identifying an individually-encrypted subset of the file.

14. The system of claim 11, wherein the application update engine is further executable to:
responsive to transmission of the download request, receive and read into volatile memory of the computing device the second data;
copy into the volatile memory the first data from the local storage location of the computing device;
within the volatile memory, combine the first data and the second data;
encrypt the combined first data and the second data; and
overwriting the application with the encrypted combined first data and the second data.

15. The system of claim 11, wherein the local storage location is a secure storage region on the computing device that is read and write accessible to a pre-authorized subset of applications including the application.

16. The system of claim 11, wherein the remote storage location includes a server of a cloud-based application distribution service.

17. The system of claim 11, wherein the first data is sourced from a previously-installed rolling patch for the application that is stored on the computing device in addition to the application.

18. One or more tangible computer-readable storage media encoding computer-executable instructions for executing a computer process for updating an application installed on a computing device, the computer process comprising:
obtaining a listing of hash identifiers (IDs) associated with an application update, each of the hash IDs identifying a data chunk included within the application update;
redacting from the listing of hash IDs a subset of the hash IDs corresponding to data chunks previously-installed by the computing device, the subset of redacted hash IDs representing first data of the application update;
generating a download request for second data of the application update, the download request identifying data chunks corresponding to the hash IDs remaining on the redacted listing;
sourcing the first data of the application update from a local storage location;
sourcing the second data of the application update from a remote storage location; and
overwriting a currently-stored version of the application with the first data and the second data.

19. (canceled)

20. The one or more tangible computer-readable storage media of claim 18, wherein the data chunk identifiers in the listing each identify an encrypted file within the available application update.
